(19) United States
(12) Patent Application Publication
(10) Pub. No.: US 2024/0396427 A1
(43) Pub. Date: Nov. 28, 2024

(54) RAMP SIGNAL GENERATOR OF SWITCH MODE POWER SUPPLY

(71) Applicant: MediaTek Singapore Pte. Ltd., Singapore (SG)

(72) Inventors: Tomohisa Shinozaki, Tokyo (JP); Jin-Yan Syu, Hsinchu City (TW); Chih-Chen Li, Hsinchu City (TW)

(73) Assignee: MediaTek Singapore Pte. Ltd., Singapore (SG)

(21) Appl. No.: 18/675,118

(22) Filed: May 27, 2024

Related U.S. Application Data
(60) Provisional application No. 63/504,477, filed on May 26, 2023.

(51) Int. Cl. H02M 1/00; H02M 3/07

(52) U.S. Cl. CPC H02M 1/0095; H02M 3/07

(57) ABSTRACT

The present invention provides a ramp signal generator of a SMPS. The ramp signal generator includes a filter and a charge pump. The filter is configured to filter a PWM signal to generate a filtered PWM signal. The charge pump is configured to receive the PWM signal and the filtered PWM signal to generate an output current, wherein the output current is used to generate a ramp signal, and the ramp signal is used for a PWM signal generator to generate the PWM signal.

### CROSS REFERENCE TO RELATED APPLICATIONS

This application claims the benefit of U.S. Provisional Application No. 63/504,477, filed on May 26, 2023. The content of the application is incorporated herein by reference.

### BACKGROUND

A switch mode power supply (SMPS) is a power converter that uses switching devices such as MOSFETs that continuously turn on and off at high frequency; and energy storage devices such as the capacitors and inductors to supply power during the non-conduction state of the switching device. In order to reduce the chip area to lower the manufacturing cost, a smaller inductor is preferred to be designed in the SMPS. However, smaller inductor is more prone to magnetic saturation, and its inductance will be decreased when the large current flows through the inductor. Therefore, it is difficult to control DC-DC stability when the inductance changes based on the current.

To solve this problem, conventional arts use a current mode or a pseudo current mode mechanism to compensate the phase delay generated by the inductor and capacitor of the SMPS. However, the current mode or the pseudo current mode mechanism may not support high-switching frequency, or may not support large/wide inductance degeneration, or may not be used under various duty conditions.

### SUMMARY

It is therefore an objective of the present invention to provide a SMPS, which supports high switching frequency and large/wide inductance degeneration, and/or can work under various duty conditions, to solve the above-mentioned problems.

According to one embodiment of the present invention, a SMPS configured to receive an input voltage to generate an output voltage is disclosed. The SMPS comprises an inductor, two power transistors, a driver, a capacitor, an error amplifier, a PWM signal generator and a ramp signal generator. The two power transistors are configured to selectively couple a first node of the inductor to an input voltage or a ground voltage. The driver is configured to control the two power transistors according to a PWM signal. The capacitor is coupled between a second node of the inductor and a ground voltage, wherein the second node of the inductor is configured to generate the output voltage. The error amplifier is configured to compare the output voltage with a reference voltage to generate a comparison result. The PWM signal generator is configured to receive the comparison result and a ramp signal to generate the PWM signal. The ramp signal generator is configured to generate the ramp signal according to the PWM signal. The ramp signal generator comprises a filter and a charge pump. The filter is configured to filter the PWM signal to generate a filtered PWM signal; and the charge pump is configured to receive the PWM signal and the filtered PWM signal to generate an output current, wherein the ramp signal is generated according to the output current.

According to one embodiment of the present invention, a ramp signal generator of a SMPS is disclosed. The ramp signal generator comprises a filter and a charge pump. The filter is configured to filter a PWM signal to generate a filtered PWM signal. The charge pump is configured to receive the PWM signal and the filtered PWM signal to generate an output current, wherein the output current is used to generate a ramp signal, and the ramp signal is used for a PWM signal generator to generate the PWM signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a SMPS according to one embodiment of the present invention

FIG. 2 shows that the ramp signal generator has a wider phase boost range to compensate the phase delay caused by inductor and capacitor.

FIG. 3 shows an equivalent circuit of part of the ramp signal generator according to one embodiment of the present invention.

FIG. 4 shows an equivalent circuit of part of the ramp signal generator according to one embodiment of the present invention.

FIG. 5 shows that the ramp signal generator has function of high-pass filter, transconductance amplifier and low-pass filter.

FIG. 6 is a diagram illustrating the ON-time generator of the PWM signal generator according to one embodiment of the present invention.

FIG. 7 is a diagram illustrating the ramp signal generator according to one embodiment of the present invention.

FIG. 8 is a diagram illustrating the ramp signal generator according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

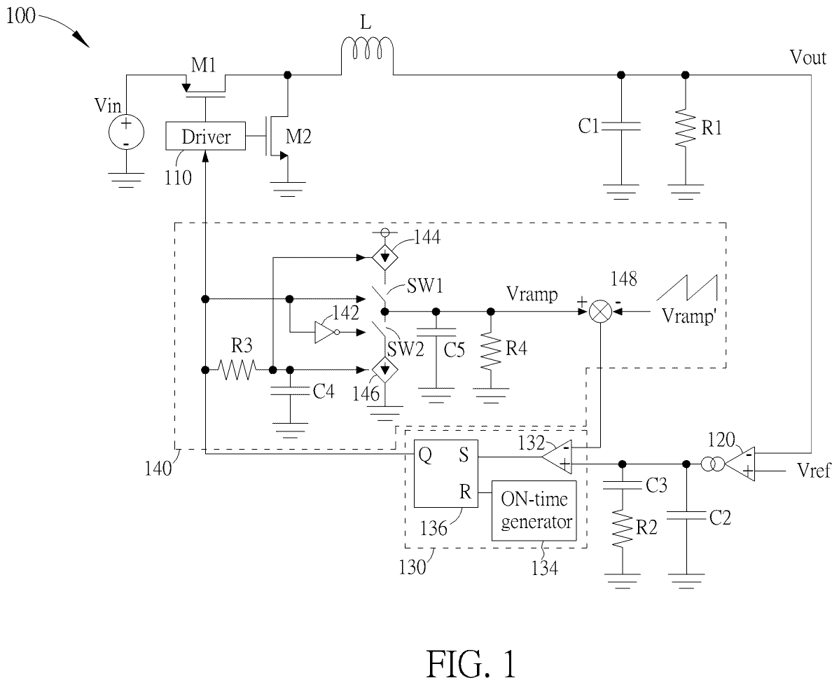

FIG. 1 is a diagram illustrating a SMPS 100 according to one embodiment of the present invention, wherein the SMPS is a DC-DC converter configured to receive an input voltage Vin to generate an output voltage Vout. As shown in FIG. 1, the SMPS 100 comprises a driver 110, two power transistors M1 and M2, an inductor L, a capacitor C1, a resistor R1, an error amplifier 120, capacitors C2 and C3, a resistor R2, a pulse-width modulation (PWM) signal generator 130 and a ramp signal generator 140. The power transistor M1 is coupled between a first node of the inductor L1 and the input voltage Vin, and is configured to selectively connect the input voltage Vin to the first node the inductor L. The power transistor M1 is coupled between the first node of the inductor L1 and a ground voltage, and is configured to selectively connect the first node of the inductor L to the ground voltage. Each of the capacitor C1 and the resistor R1 is coupled between the second node of the inductor and the ground voltage. The error amplifier 120 is configured to compare the output voltage with a reference voltage Vref to generate a comparison result, and this comparison result is inputted into the PWM signal generator via the capacitors C2, C3 and the resistor R2. The PWM signal generator 130 comprises a comparator 132, an ON-time generator 134 and a flip-flop 136, wherein the comparator 132 is configured to the compare the compared result generated by the error amplifier 120 with a ramp signal generated by the ramp signal generator 140 to generate a comparison result, and the flip-flop 136 receives the comparison result generated by the comparison result of the comparator 132 to generate a PWM signal based on a reset signal generated by the ON-time generator 134. The driver 110 receives the PWM signal to enable the power transistors M1 and M2 alternately.

It is noted that the main operations of the SMPS 100 are known by a person skilled in the art, and the focus of the present invention is the ramp signal generator 140, so the operations of other elements such as the driver 110, power transistors M1 and M2, inductor L, error amplifier 120 and the PWM signal generator 130 are omitted here.

The ramp signal generator 140 comprises a resistor R3, a capacitor C4, a charge pump comprising an inverter 142, two switches SW1 and SW2 and two current sources 144 and 146, a capacitor C5, a resistor R4 and a combiner 148. In the ramp signal generator 140 shown in FIG. 1, a first node of the resistor R3 is used to receive the PWM signal, a first node of the capacitor C4 is coupled to a second node of the resistor R3, and a second node of the capacitor C4 is coupled to the ground voltage. The resistor R3 and the capacitor C4 can be regarded as a low-pass filter, and the PWM signal pass though the resistor R3 and the capacitor C4 to generate a filtered PWM signal, wherein the filtered PWM signal is used to control the current amount of the current sources 144 and 146 of the charge pump. The switches SW1 and SW2 of the charge pump are controlled by the PWM signal. The output current of the charge pump passes through the capacitor C5 and the resistor R4 to generate a pseudo current signal serving as a ramp signal Vramp, and the combiner 148 combines the ramp signal Vramp with a preset ramp signal Vramp′ to generate the output ramp signal to the PWM signal generator 130. In addition, in the embodiment shown in FIG. 1, a lower node of the resistor R4 is coupled to the ground voltage, but this feature is not a limitation of the present invention. In other embodiments, the lower node of the resistor R4 may be coupled to any suitable low voltage, wherein the ramp signal Vramp will not be centered at this low voltage.

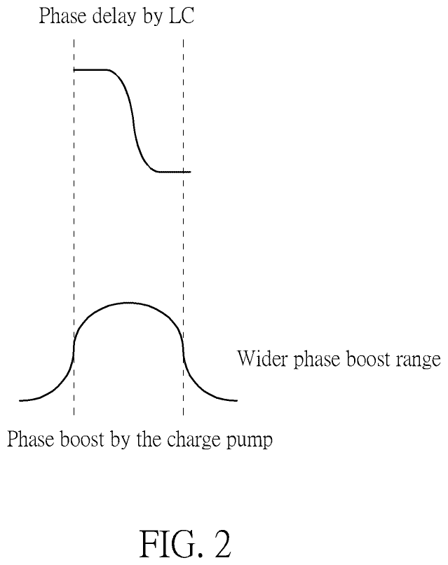

In the embodiment shown in FIG. 1, the PWM signal does not contain the noise from the power transistors M1 and M2, so the SMPS 100 can support high switching frequency. In addition, by using the control mechanism of the charge pump, the output current of the charge pump becomes zero for one cycle, so the ramp signal generator 140 can be used for all condition with different duty cycles of the PWM signal. Furthermore, referring to FIG. 2, the ramp signal generator 140 has a wider phase boost range to compensate the phase delay caused by the inductor L and the capacitor C1, so the ramp signal generator 140 can support the large inductance degeneration.

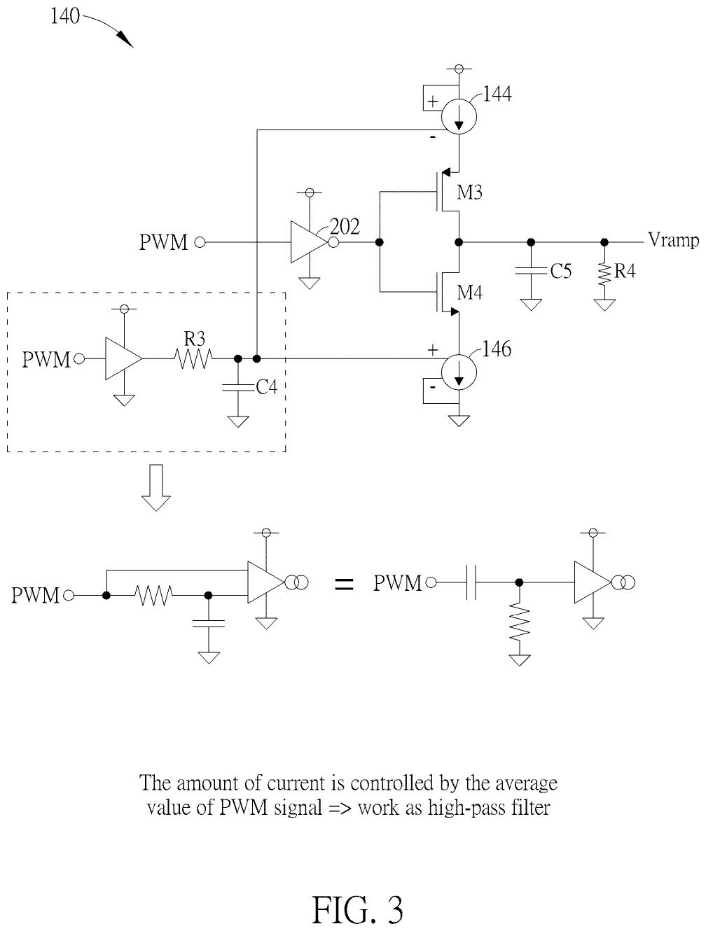

Specifically, referring to FIG. 3, wherein one inverter 202 and two transistors are used to implement the inverter 142 and two switches SW1 and SW2 shown in FIG. 1. As shown in FIG. 3, because the current sources 144 and 146 are controlled by the filtered PWM signal, and the filtered PWM signal can be regarded as an average value (or average level) of the PWM signal, together with the following charge pump, the resistor R3 and the capacitor C4 also work as a high-pass filter to block a DC component of the PWM signal.

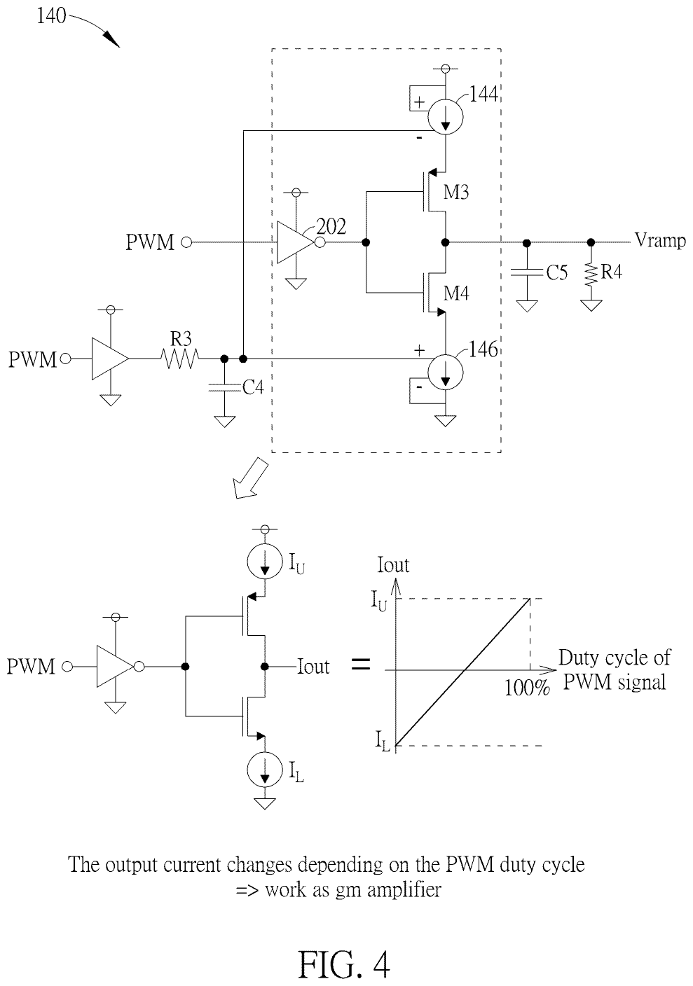

In addition, referring to FIG. 4, an output current Iout of the charge pump changes based on the duty cycle of the PWM signal, so the charge pump works as a transconductance amplifier (gm amplifier).

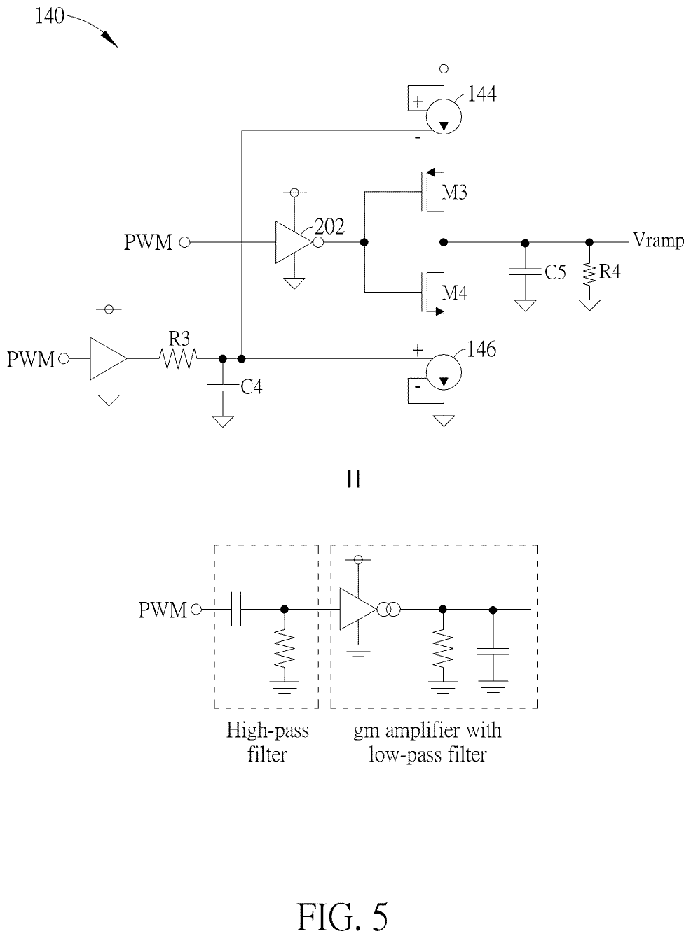

Referring to FIG. 5, overall, the ramp signal generator 140 has function of high-pass filter, transconductance amplifier with low-pass filter, wherein the high-pass filter is used to block the DC component of the PWM signal, and the transconductance amplifier with low-pass filter is used to provide gain higher than one (i.e., greater than 0 dB) and compensate the phase delay caused by the inductor L1 and the capacitor C1.

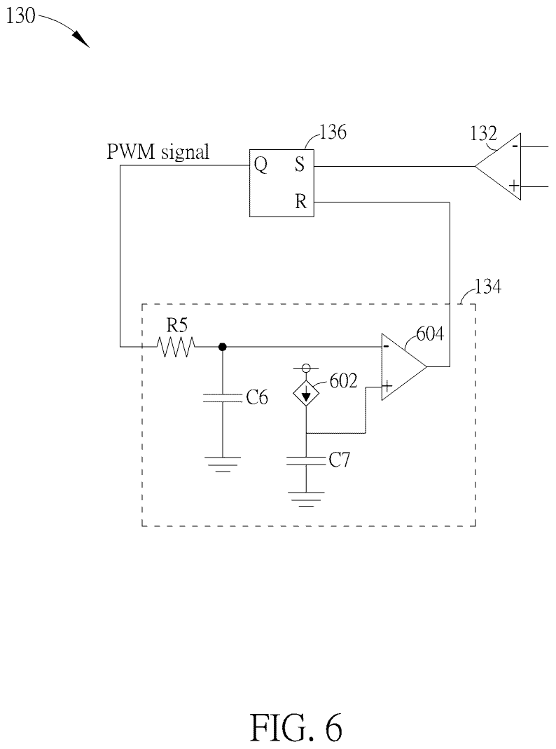

FIG. 6 is a diagram illustrating the ON-time generator 134 of the PWM signal generator 130 according to one embodiment of the present invention. As shown in FIG. 6, the ON-time generator 134 comprises a resistor R5, a capacitor C6, a current source 602, a capacitor C7 and a comparator 604. In the operation of the ON-time generator 134, the resistor R5 and the capacitor C6 serve as a low-pass filter to filter the PWM signal to generate a filtered PWM signal, wherein the filtered PWM signal can be regarded as an average value (or average level) of the PWM signal. The current source 602 and the capacitor C7 are used to provide a reference voltage to the comparator 604. The comparator 604 compares the reference voltage with the filtered PWM signal to generate a reset signal to trigger the flip-flop 136.

In one embodiment, the PWM signal generator 130 and the ramp signal generator 140 may share the low-pass filter to reduce the chip area. Specifically, the resistor R5 and the capacitor C6 can be removed from the PWM signal generator 130, and the comparator 604 compares the reference voltage with the filtered PWM signal generated by the resistor R3 and capacitor C4 shown in FIG. 1 to generate the reset signal to trigger the flip-flop 136.

It is noted that the ON-time generator 134 and the PWM signal generator 130 shown in FIG. 6 are for illustrative, not a limitation of the present invention. As long as the PWM signal generator 130 can generate the PWM signal by comparing the comparison result of the error amplifier 120 with the ramp signal generated by the ramp signal generator 140, the PWM signal generator 130 may have different circuit designs.

In one embodiment of the present invention, output current of the charge pump is designed to be zero for every one cycle. Specifically, for each cycle, the charge current is proportional to (Vin−D*Vin)*D, and the discharge current is proportional to D*Vin*(1−D), wherein “D” represents the duty cycle of the PWM signal, and “Vin” serves as a high-level of the PWM signal. Therefore, since the charge current is equal to the discharge current within one cycle, the ramp signal generator 140 can be used under different duty cycles of the PWM signal without additional circuit designs.

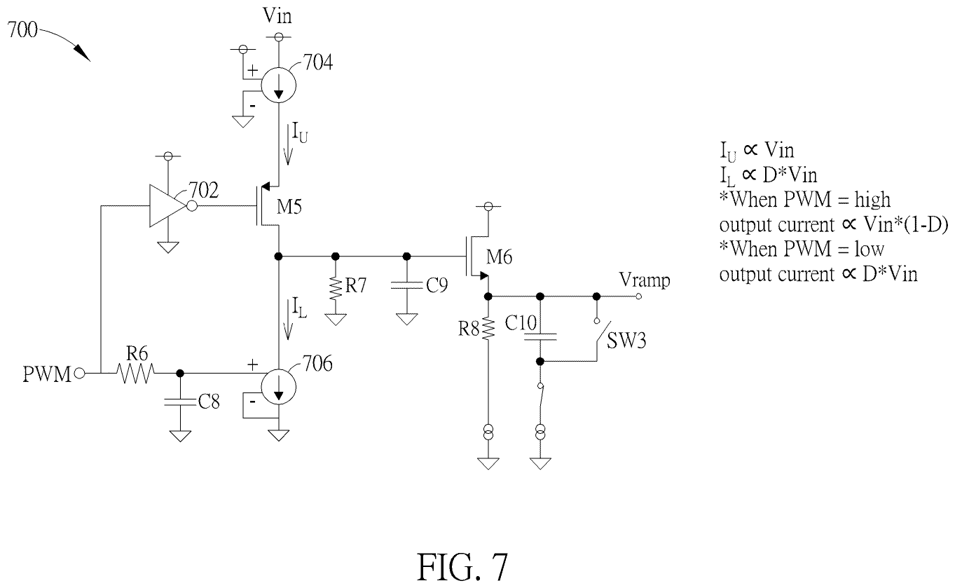

FIG. 7 is a diagram illustrating the ramp signal generator 700 according to one embodiment of the present invention, wherein the ramp signal generator 700 can be used to replace the ramp signal generator 140 shown in FIG. 1. The ramp signal generator 700 comprises a resistor R6, a capacitor C8, a charge pump comprising an inverter 702, a transistor M5, two current sources 704 and 706, a resistor R7, a capacitor C9, a transistor M6, a resistor R8, a capacitor C10 and a switch SW3. In the ramp signal generator 700 shown in FIG. 7, a first node of the resistor R6 is used to receive the PWM signal, a first node of the capacitor C8 is coupled to a second node of the resistor R6, and a second node of the capacitor C8 is coupled to the ground voltage. The PWM signal pass though the resistor R6 and the capacitor C8 to generate a filtered PWM signal, wherein the filtered PWM signal is used to control the current amount of the current source 706 of the charge pump. The transistor M5 is controlled by the PWM signal via the inverter 702. The output current of the charge pump passes through the resistor R7 and the capacitor C9 to generate a voltage signal to the transistor M6. Then, the transistor M6 receives the voltage signal to generate a pseudo current signal serving as a ramp signal Vramp.

In the embodiment shown in FIG. 7, the current I_{U} provided by the current source 704 is proportional to “Vin”, and the current I_{L} provided by the current source 706 is proportional to “D*Vin” (the filtered PWM signal generated by the resistor R6 and the capacitor C8 is about D*Vin). Therefore, when the PWM signal has a high-voltage level (e.g. Vin), the transistor M5 is enabled, and the output current is proportional to (Vin−D*Vin) (the current flowing from the output node of the charge pump to the transistor M6); and when the PWM signal has a low-voltage level (e.g. 0V or the ground voltage), the transistor M5 is disabled, and the output current is proportional to (D*Vin) (the current flowing from the output node of the charge pump to the ground). In light of above, the charge current amount within one cycle will be proportional to (Vin−D*Vin)*D, and the discharge current amount within one cycle will be proportional to D*Vin*(1−D), so the charge current is equal to the discharge current within one cycle, and the ramp signal generator 140 can be used under different duty cycles of the PWM signal.

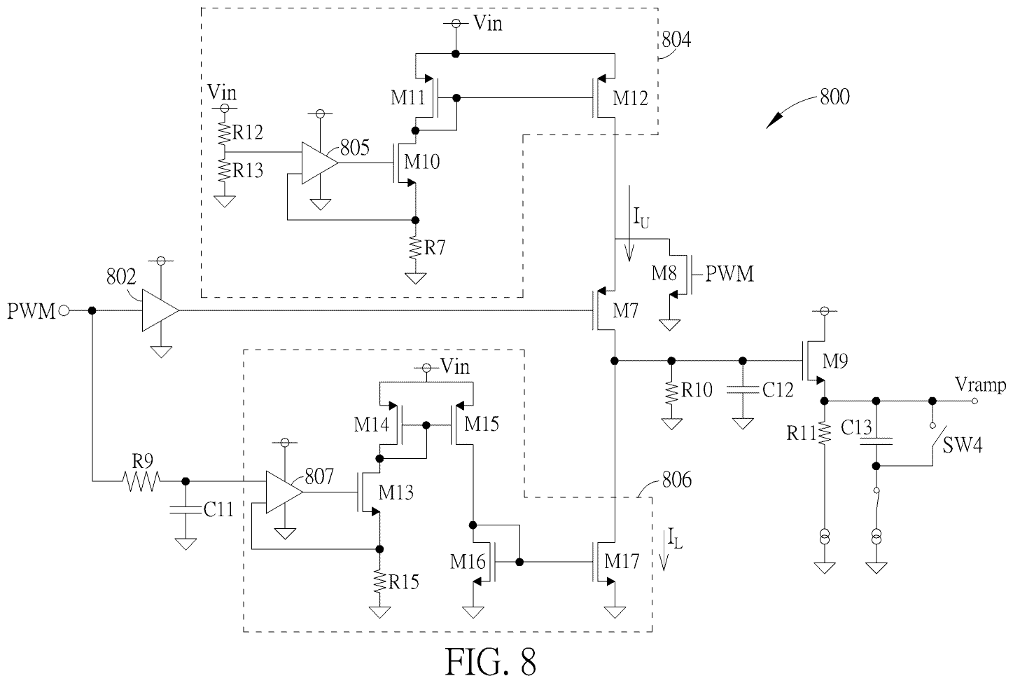

FIG. 8 is a diagram illustrating the ramp signal generator 800 according to one embodiment of the present invention, wherein the ramp signal generator 800 can be used to replace the ramp signal generator 140 shown in FIG. 1. The ramp signal generator 800 comprises a resistor R9, a capacitor C11, a charge pump comprising an inverter 802, two transistor M7 and M8, two current sources 804 and 806, a resistor R10, a capacitor C12, a transistor M9, a resistor R11, a capacitor C13 and a switch SW4. The current source 804 comprises resistors R12, R13 and R14, an operational amplifier 805 and transistors M10, M11 and M12. The current source 806 comprises am operational amplifier 805, a resistor R15 and transistors M13-M17. In the ramp signal generator 800 shown in FIG. 8, a first node of the resistor R9 is used to receive the PWM signal, a first node of the capacitor C11 is coupled to a second node of the resistor R9, and a second node of the capacitor C11 is coupled to the ground voltage. The PWM signal pass though the resistor R9 and the capacitor C11 to generate a filtered PWM signal, wherein the filtered PWM signal is used to control the current amount of the current source 806 of the charge pump. The transistors M7 and M8 are controlled according to the PWM signal. The output current of the charge pump passes through the resistor R10 and the capacitor C12 to generate a voltage signal to the transistor M9. Then, the transistor M9 receives the voltage signal to generate a pseudo current signal serving as a ramp signal Vramp.

In the embodiment shown in FIG. 8, the current I_{U} provided by the current source 804 is proportional to “Vin”, and the current I_{L} provided by the current source 806 is proportional to “D*Vin” (the filtered PWM signal generated by the resistor R9 and the capacitor C11 is about D*Vin). Therefore, when the PWM signal has a high-voltage level (e.g. Vin), the transistor M7 is enabled, and the output current is proportional to (Vin−D*Vin); and when the PWM signal has a low-voltage level (e.g. 0V or the ground voltage), the transistor M7 is disabled, and the output current is proportional to (D*Vin). In light of above, the charge current amount within one cycle will be proportional to (Vin−D*Vin)*D, and the discharge current amount within one cycle will be proportional to D*Vin*(1−D), so the charge current is equal to the discharge current within one cycle, and the ramp signal generator 140 can be used under different duty cycles of the PWM signal.

Referring to the embodiment shown in FIG. 1, FIG. 7 and FIG. 8, as long as the ramp signal generator has a charge pump whose switch is controlled by the PWM signal, at least one of the current sources of the charge pump is controlled by a filtered PWM signal (or an average value/level of the PWM signal), the ramp signal generator may have different circuit designs for generating the ramp signal to the PWM signal generator 130. In one embodiment, the charge pump is with a low-pass filter at the output node to boost the phase to compensate the phase delay caused by the inductor L and the capacitor C1. In another embodiment, the current sources of the charge pump are designed to make the charge current be equal to the discharge current within one cycle (one PWM cycle), so that the ramp signal generator can be used under different duty cycles of the PWM signal.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A switch mode power supply (SMPS), configured to receive an input voltage to generate an output voltage, wherein the SMPS comprises:
an inductor;
two power transistors, configured to selectively couple a first node of the inductor to an input voltage or a ground voltage;
a driver, configured to control the two power transistors according to a pulse-width modulation (PWM) signal;
a capacitor, coupled between a second node of the inductor and a ground voltage, wherein the second node of the inductor is configured to generate the output voltage;
an error amplifier, configured to compare the output voltage with a reference voltage to generate a comparison result;
a PWM signal generator, configured to receive the comparison result and a ramp signal to generate the PWM signal; and
a ramp signal generator, configured to generate the ramp signal according to the PWM signal;
wherein the ramp signal generator comprises:
a filter, configured to filter the PWM signal to generate a filtered PWM signal; and
a charge pump, configured to receive the PWM signal and the filtered PWM signal to generate an output current, wherein the ramp signal is generated according to the output current.

2. The SMPS of claim 1, wherein the filter is a low-pass filter.

3. The SMPS of claim 1, wherein the ramp signal generator comprises:
a first current source, coupled between the input voltage and an output node of the charge pump, configured to provide a first current to the output node of the charge pump;
a first switch, configured to selectively coupled the first current source to the output node of the charge pump; and
a second current source, coupled between a ground voltage and the output node of the charge pump, configured to provide a second current to the output node of the charge pump;
wherein the first switch is controlled by the PWM signal, and the second current source is controlled by the filtered PWM signal.

4. The SMPS of claim 3, wherein the ramp signal generator further comprises:
a second switch, configured to selectively coupled the second current source to the output node of the charge pump, wherein the second switch is controlled by the PWM signal.

5. The SMPS of claim 3, wherein the first current source is controlled by the filtered PWM signal.

6. The SMPS of claim 3, wherein a value of the first current is proportional to the input voltage, and a value of the second current is proportional to the input voltage multiplied by a duty cycle of the PWM signal.

7. The SMPS of claim 6, wherein for output node of the charge pump, a charge current is equal to a discharge current within one PWM cycle.

8. The SMPS of claim 1, wherein the charge pump is with a low-pass filter at the output node.

9. The SMPS of claim 1, wherein the charge pump works as a transconductance amplifier.

10. A ramp signal generator of a switch mode power supply (SMPS), comprising:
a filter, configured to filter a pulse-width modulation (PWM) signal to generate a filtered PWM signal; and
a charge pump, configured to receive the PWM signal and the filtered PWM signal to generate an output current, wherein the output current is used to generate a ramp signal, and the ramp signal is used for a PWM signal generator to generate the PWM signal.

11. The ramp signal generator of claim 10, wherein the filter is a low-pass filter.

12. The ramp signal generator of claim 10, wherein the ramp signal generator comprises:
a first current source, coupled between the input voltage and an output node of the charge pump, configured to provide a first current to the output node of the charge pump;
a first switch, configured to selectively coupled the first current source to the output node of the charge pump; and
a second current source, coupled between a ground voltage and the output node of the charge pump, configured to provide a second current to the output node of the charge pump;
wherein the first switch is controlled by the PWM signal, and the second current source is controlled by the filtered PWM signal.

13. The ramp signal generator of claim 12, wherein the ramp signal generator further comprises:
a second switch, configured to selectively coupled the second current source to the output node of the charge pump, wherein the second switch is controlled by the PWM signal.

14. The ramp signal generator of claim 12, wherein the first current source is controlled by the filtered PWM signal.

15. The ramp signal generator of claim 12, wherein a value of the first current is proportional to the input voltage, and a value of the second current is proportional to the input voltage multiplied by a duty cycle of the PWM signal.

16. The ramp signal generator of claim 15, wherein for output node of the charge pump, a charge current is equal to a discharge current within one PWM cycle.

17. The ramp signal generator of claim 10, wherein the charge pump is with a low-pass filter at the output node.

18. The ramp signal generator of claim 10, wherein the charge pump works as a transconductance amplifier.
